(19) United States
(12) Patent Application Publication
(10) Pub. No.: US 2011/0031817 A1
(43) Pub. Date: Feb. 10, 2011

(54) RECTIFYING ANTENNA ARRAY

(75) Inventors: Jong Moo Lee, Daejeon (KR); Yong Hae Kim, Daejeon (KR); Myung Lae Lee, Daejeon (KR); Sang Hoon Cheon, Daejeon (KR); Seung Youl Kang, Daejeon (KR); Tae Hyoung Zyung, Daejeon (KR); Sang Gi Kim, Daejeon (KR); Jin Ho Lee, Daejeon (KR)

Correspondence Address: AMPACC Law Group, PLLC, 6100 219th Street SW, Suite 580, Mountlake Terrace, WA, 98043, US

(73) Assignee: Electronics and Telecommunications Research Institute, Daejeon (KR)

(21) Appl. No.: 12/833,830

(22) Filed: Jul. 9, 2010

(30) Foreign Application Priority Data
Aug. 6, 2009 (KR) 10-2009-0072396
Dec. 8, 2009 (KR) 10-2009-0121287

(51) Int. Cl. H02J 17/00

(52) U.S. Cl. 307/104

(57) ABSTRACT

A rectifying antenna array includes a plurality of rectifying antennas connected in parallel. Each of the rectifying antennas includes a reception-side antenna receiving AC power through magnetic induction with a reception-side resonant antenna of a resonant wireless power receiver and a rectifier diode connected to the reception-side antenna and converting the AC power into DC power.

### CROSS-REFERENCE TO RELATED APPLICATIONS

This application claims the priorities of Korean Patent Application Nos. 10-2009-0072396 filed on Aug. 6, 2009 and 10-2009-0121287 filed on Dec. 8, 2009, in the Korean Intellectual Property Office, the disclosures of which are incorporated herein by reference.

### BACKGROUND OF THE INVENTION

1. Field of the Invention

The present invention relates to a rectifying antenna array, and more particularly, to technology which implements rectifying antennas of a resonant wireless power receiver into an antenna array such that received high-frequency AC power may be easily converted into DC power.

2. Description of the Related Art

Wireless power transfer technology refers to technology which wirelessly transfers and receives power without using a wire. Resonant wireless power transfer technology refers to technology which matches resonant frequencies through magnetic inductive coupling between two coils and thus maximizes energy transmissions to transfer and receive power.

FIG. 1 is a diagram illustrating a conventional resonant wireless power transfer structure. Referring to FIG. 1, the conventional resonant wireless power transfer system includes a resonant wireless power transmitter containing a source coil and a transmitting coil and a resonant wireless power receiver containing a receiving coil and a load coil.

Power input to the source coil of the resonant wireless power transmitter is transferred to the transmitting coil by magnetic induction. The transmitting coil operates as a resonator, and wirelessly transfers power through resonance with the receiving coil of the resonant wireless power receiver. At this time, the transmitting coil and the receiving coil are designed in such a manner as to have the same resonant frequency. The power transferred to the receiving coil is transferred to the load coil by magnetic induction, and an electronic device consuming power is connected to the load coil.

According to the resonant wireless power transfer technology, the energy transmission efficiency at a resonant frequency of 10 MHz or more reaches 60% or more even at a relative remote distance of 1 m or more, a considerably large percentage.

In such a resonant wireless power transfer structure, however, the power received by the resonant wireless power receiver is the same high-frequency AC power as the power inputted to the resonant wireless power transmitter. Therefore, the high-frequency AC power should be converted into DC power, as it is difficult to directly use the high-frequency AC power as a power source. In general, however, a widely-used high-speed rectifier diode is used at a low power level of 1 W or less. Therefore, there are technical difficulties in converting AC power into DC power using the rectifier diode at the power of 1 W or more.

### SUMMARY OF THE INVENTION

An aspect of the present invention provides a rectifying antenna array in which rectifying antennas of a resonant wireless power receiver are implemented in an antenna array such that received high-frequency AC power may be easily converted into DC power.

According to an aspect of the present invention, there is provided a rectifying antenna array including a plurality of rectifying antennas connected in parallel. Each of the rectifying antennas includes: a reception-side antenna receiving AC power through magnetic induction with a reception-side resonant antenna of a resonant wireless power receiver; and a rectifier diode connected to the reception-side antenna and converting the AC power into DC power.

The respective rectifying antennas may receive power through magnetic inductive coupling with the reception-side resonant antenna, depending on predetermined coupling coefficients.

The predetermined coupling coefficients for the respective rectifying antennas may have values that are approximately equal to each other and are set to satisfy the following condition: a coupling coefficient between a power side antenna and a transmission-side resonant antenna of a resonant wireless power transmitter×the sum of the predetermined coupling coefficients≈a coupling coefficient between the transmission-side resonant antenna of the resonant wireless power transmitter and the reception-side resonant antenna of the resonant wireless power receiver.

The number of rectifying antennas may increase in proportion to the magnitude of the AC power.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating a conventional resonant wireless power transfer structure;

FIG. 2 is a diagram illustrating a rectifying antenna array structure according to an embodiment of the present invention; and

FIG. 3 is a diagram illustrating a rectifier circuit using four rectifier diodes.

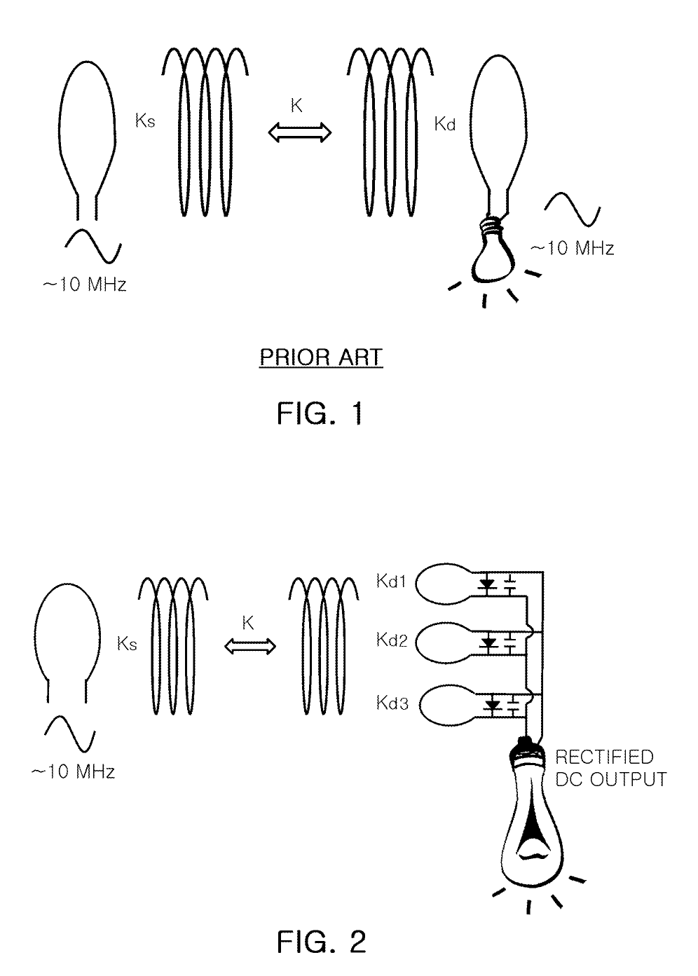

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Like reference numerals in the drawings denote like elements, and thus their description will be omitted.

FIG. 2 is a diagram illustrating a rectifying antenna array structure according to an embodiment of the present invention.

Referring to FIG. 2, rectifying antennas of a resonant wireless power receiver according to the embodiment of the present invention are configured in a rectifying antenna array. The respective rectifying antennas composing the rectifying antenna array receive power through magnetic induction with a reception-side resonant antenna depending on predetermined coupling coefficients K_{d1}, K_{d2}, and K_{d3}.

At this time, the predetermined coupling coefficients K_{d1}, K_{d1}, and K_{d3} for the respective rectifying antennas are set as follows, while maintaining values approximately equal to each other.

K²≈Kₛ²×(K_{d1}²+K_{d2}²+K_{d3}²)

That is, a coupling coefficient between resonant rings, i.e., between a transmission-side resonant antenna and a reception-side resonant antenna is set to be maintained to almost the same value as the product of the transmitter-side coupling coefficient and the sum of the reception-side coupling coefficients. Then, the rectifying loads of the respective rectifying antennas of the receiver may be distributed at a high level of transfer efficiency. Here, Kₛ represents the coupling coefficient between the power-side antenna and the transmission-side resonant antenna of the resonant wireless power transmitter, and K represents the coupling coefficient between the transmission-side resonant antenna of the resonant wireless power transmitter and the reception-side resonant antenna of the resonant wireless power receiver.

The AC power received by each of the antennas may be converted into DC power by a rectifier diode connected to the antenna. At this time, a generally-used rectifier diode capable of converting low power of 1 W or less may be used as the rectifier diode. Furthermore, the power to be converted increases in proportion to the number of rectifying antennas composing the rectifying antenna array.

For example, it may be assumed that AC power received by the resonant wireless power receiver is 13.5 MHz. In this case, when four 1 W rectifier diodes are connected in parallel, power of 4 W may be rectified. When ten 1 W rectifier diodes are connected in parallel, power of 10 W may be rectified. Therefore, depending on the power required by a device which is connected to the resonant wireless power receiver and consumes power, for example, a small-sized portable device such as portable terminal or notebook computer, a proper number of rectifier diodes may be connected in parallel to receive the necessary amount of power.

As such, when the rectifying antenna array according to the embodiment of the present invention is used, the number of antennas may be adjusted depending on the power to be converted. Then, AC power of 10 MHz or more may be easily converted into DC power.

Except in the case that the rectifying antennas are configured in a rectifying antenna array, the structure of the conventional resonant wireless power transfer system may be used without any modification, in order to perform the wireless power transfer. That is, the resonant wireless power transmitter includes the power-side antenna and the transmission-side resonant antenna, and the resonant wireless power receiver includes the reception-side resonant antenna and the rectifying antenna array. The resonant wireless power transfer system wirelessly transfers power through the magnetic induction and the resonance between the antennas.

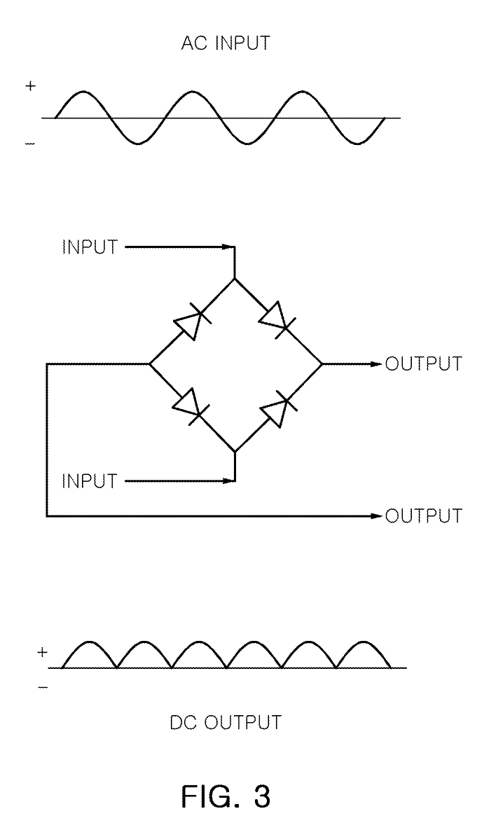

FIG. 3 is a diagram illustrating a rectifier circuit using four rectifier diodes.

In the rectifying antenna array illustrated in FIG. 2, one rectifier diode connected to each of the antennas may be replaced with the rectifier circuit illustrated in FIG. 3. Then, it is possible to convert AC power into DC power more effectively.

According to the embodiment of the present invention, the rectifying antennas of the resonant wireless power receiver are implemented in an antenna array such that high-power reception may be performed using a generally used high-speed rectifier diode array.

While the present invention has been shown and described in connection with the exemplary embodiments, it will be apparent to those skilled in the art that modifications and variations can be made without departing from the spirit and scope of the invention as defined by the appended claims.

What is claimed is:

1. A rectifying antenna array comprising a plurality of rectifying antennas connected in parallel,
wherein each of the rectifying antennas comprises:
a reception-side antenna receiving AC power through magnetic induction with a reception-side resonant antenna of a resonant wireless power receiver; and
a rectifier diode connected to the reception-side antenna and converting the AC power into DC power.

2. The rectifying antenna array of claim 1, wherein the respective rectifying antennas receive power through magnetic inductive coupling with the reception-side resonant antenna, depending on predetermined coupling coefficients.

3. The rectifying antenna array of claim 2, wherein the predetermined coupling coefficients for the respective rectifying antennas have values approximately equal to each other and are set to satisfy the following condition:
a coupling coefficient between a power side antenna and a transmission-side resonant antenna of a resonant wireless power transmitter×the sum of the predetermined coupling coefficients≈a coupling coefficient between the transmission-side resonant antenna of the resonant wireless power transmitter and the reception-side resonant antenna of the resonant wireless power receiver.

4. The rectifying antenna array of claim 1, wherein the number of rectifying antennas increases in proportion to the magnitude of the AC power.
